(19) United States
(12) Patent Application Publication
(10) Pub. No.: US 2017/0242098 A1
(43) Pub. Date: Aug. 24, 2017

(54) Radar Apparatus

(71) Applicants: TRW Autocruise S.A.S., Plouzané (FR); TRW Limited, West Midlands (GB)

(72) Inventors: Frantz Bodereau, Plouzané (FR); Luke Symmons, Shirley (GB); Andrew James Stephen Williams, Lapworth (GB)

(73) Assignees: TRW Autocruise S.A.S., Plouzané (FR); TRW Limited, West Midlands (GB)

(21) Appl. No.: 15/436,229

(22) Filed: Feb. 17, 2017

(30) Foreign Application Priority Data
Feb. 18, 2016 (EP) 16290039.3
Mar. 31, 2016 (GB) 1605439.7

(51) Int. Cl. G01S 7/40

(52) U.S. Cl. CPC G01S 7/4008; G01S 2007/4013

(57) ABSTRACT

A radar apparatus includes a signal generation unit and a temperature sensing means. The signal generation unit is arranged to generate radar signals at an output power and has an output for the radar signals. The temperature sensing means has an output and is arranged to produce an output signal indicative of a temperature of at least part of the radar apparatus. The output of the temperature sensor is coupled to the signal generation unit. The signal generation unit is configured so the output power is a first power when the output signal is indicative of a temperature within a first temperature range and is a second power lower than the first power when the output signal is indicative of a temperature within a second temperature range higher than the first temperature range.

### CROSS-REFERENCE TO RELATED APPLICATIONS

This application claims priority from U.K. Patent Application No. 1605439.7, filed Mar. 31, 2016 and European Patent Application No. 16290039.3, filed Feb. 18, 2016. The disclosures of both applications are incorporated herein by reference.

### BACKGROUND OF THE INVENTION

This invention relates to a radar apparatus, and to a method of operating such apparatus.

Radar apparatus, especially for automotive applications such as automatic cruise control or automatic emergency braking, are well known. Generally, they comprise a source of radar signals, a transmitter for the radar signals, and reception and processing apparatus. Such a system is known from, for example, the PCT patent application published as WO2004/053521.

However, particularly where such radar apparatus are deployed in such harsh environments as the engine compartment of an automobile, they necessarily only have a finite temperature range in which they will operate. Typically, above a limit, say 85 degrees centigrade, it is necessary to cease operation of the circuit, as it will either not function correctly, or may even become damaged so that it is not operational when the temperature returns to within its normal operating range. Furthermore, continued operation can itself make the temperature problem worse, as such radar apparatus generate heat during operation; if operated at a temperature above the normal operating range, the heat produced may further increase the temperature thus reinforcing the deleterious effects of the high temperatures.

### SUMMARY OF THE INVENTION

According to a first aspect of the invention, there is provided a radar apparatus, comprising:
a signal generation unit arranged to generate radar signals at an output power, the signal generating unit having an output for the radar signals,
temperature sensing means having an output and arranged to produce at its output an output signal indicative of a temperature of at least part of the radar apparatus, the output of the temperature sensor being coupled to the signal generation unit,
in which the signal generation unit is configured so the output power is a first power when the output signal is indicative of a temperature within a first temperature range and is a second power lower than the first power when the output signal is indicative of a temperature within a second temperature range higher than the first temperature range.

As such, we have appreciated that a functional radar apparatus can still be achieved that can function at higher temperatures than otherwise would be the case by reducing the power transmitted at higher temperatures, potentially avoiding or at least partially ameliorating at least some of the deleterious effects described above. The inventors have appreciated that a radar apparatus will still function sufficiently well at low power to be useful.

In one embodiment, the first and second temperature ranges may be adjacent (in that the highest temperature of the first temperature range may be the same as the lowest temperature of the second temperature range). Alternatively, there may be a third temperature range between the first and second temperature ranges. The signal generation unit may be arranged so as to decrease the output power as the output signal indicates a temperature increasing through the third range, typically from the first power to the second power, and typically linearly.

The second power may be 3 decibels less than the first power, to within 0.5, 0.25 or 0.1 decibels. Typically, the highest temperature in the first range may be between 80 and 90 degrees Celsius, typically around 85 degrees Celsius (±1 degree).

Additionally, the signal generation unit may be arranged so as to cease generating radar signals should the output signal indicate a temperature above a threshold, the threshold typically being higher than the second range.

The radar apparatus may comprise a transmitter for the radar signals, coupled to the output of the signal generation unit. Typically, the transmitter will comprise at least one antenna. Each antenna may be a planar patch antenna. The transmitter may have a transmission pattern such that, at a given field strength, the radar signals are transmitted less far but over a wider angular field at the second power than at the first power.

The radar apparatus may also comprise a receiver for receiving radar signals (received radar signals), which may comprise at least one receiving antenna. Typically, the radar apparatus may comprise a reception unit which is arranged to detect and process the received radar signals.

According to a second aspect of the invention, there is provided a method of operating a radar apparatus, comprising:
generating radar signals at an output power using the radar apparatus;
measuring the temperature of at least part of the radar apparatus; and
varying the output power to a first power when the temperature is within a first temperature range and to a second power lower than the first power when temperature is within a second temperature range higher than the first temperature range.

As such, we have appreciated that a functional radar apparatus can still be achieved that can function at higher temperatures than otherwise would be the case by reducing the power transmitted at higher temperatures. The inventors have appreciated that a radar apparatus will still function sufficiently well at low power to be useful.

In one embodiment, the first and second temperature ranges may be adjacent (in that the highest temperature of the first temperature range may be the same as the lowest temperature of the second temperature range). Alternatively, there may be a third temperature range between the first and second temperature ranges. The method may comprise decreasing the output power as the temperature increases through the third range, typically from the first power to the second power.

The second power may be 3 decibels less than the first power, to within 0.5, 0.25 or 0.1 decibels. Typically, the highest temperature in the first range may be between 80 and 90 degrees Celsius, typically around 85 degrees Celsius (±1 degree).

Additionally, method may comprise ceasing to generate radar signals should the output signal indicate a temperature above a threshold, the threshold typically being higher than the second range.

The method may comprise transmitting the radar signals, typically using at least one antenna. Each antenna may be planar patch antenna. The antenna(s) may have a transmission pattern such that, at a given field strength, the radar signals are transmitted less far but over a wider angular field at the second power than at the first power.

The method may also comprise receiving received radar signals, typically using at least one receiving antenna. Typically, the method may comprise detecting and processing the received radar signals.

The method may comprise the use of the radar apparatus of the first aspect of the invention.

Various aspects of this invention will become apparent to those skilled in the art from the following detailed description of the preferred embodiment, when read in light of the accompanying drawings.

### BRIEF DESCRIPTION OF THE DRAWINGS

FIG. 1 shows a schematic diagram depicting a radar apparatus in accordance with an embodiment of the invention;

FIG. 2 shows a graph of output power against temperature of the radar apparatus of FIG. 1;

FIGS. 3a and 3b depict the beam pattern of the radar apparatus of FIG. 1 at different powers in a first mode;

FIGS. 4a and 4b depict the beam pattern of a radar apparatus of FIG. 1 in a second mode; and

FIG. 5 depicts an alternative graph of output power against temperature of the radar apparatus of FIG. 1.

### DETAILED DESCRIPTION OF THE PREFERRED EMBODIMENTS

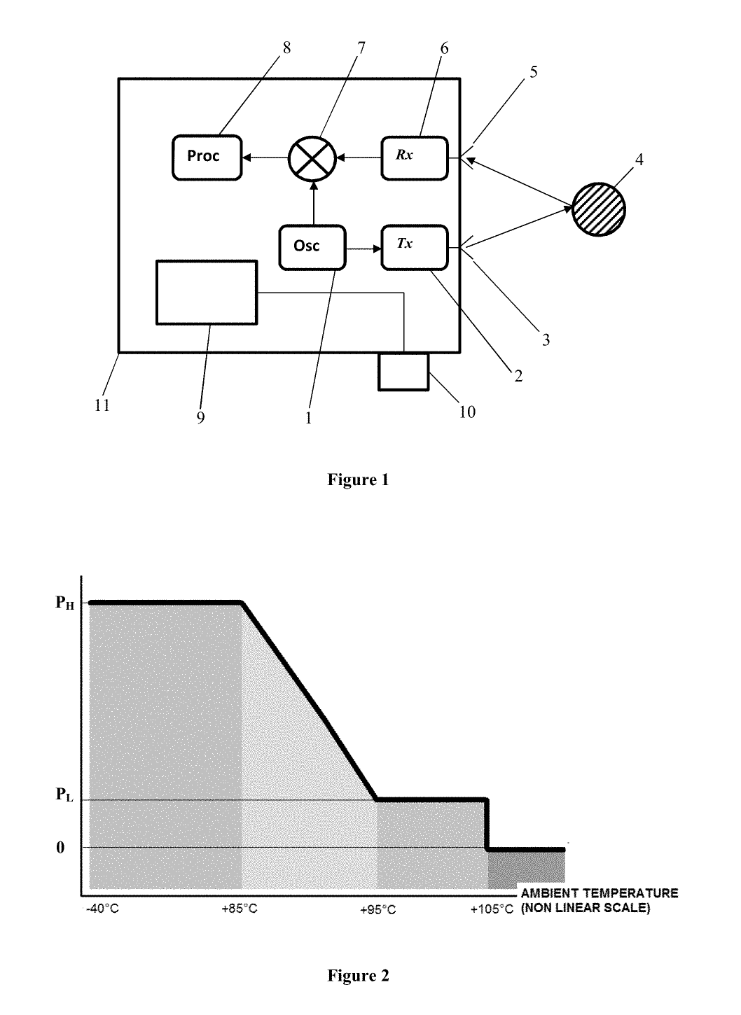

A radar apparatus in accordance with a first embodiment of the invention is shown in FIG. 1 of the accompanying drawings. The radar apparatus comprises a signal generation unit 1 of the form of an oscillator, which generates radar signals. The signal generation unit 1 has an output which is coupled to a transmitter circuit 2 which is itself coupled to a transmission antenna 3.

The transmission antenna 3 is arranged to transmit the radar signals to an area where there may be targets 4. Radar signals reflected off the targets 4 are received by a reception antenna 5 and processed by a reception circuit 6 and passed to a mixer 7, which downmixes the received radar signals with a portion of the generated radar signal for processing by a processor 8.

A control unit 9 such as a microprocessor controls the operation of the radar apparatus. The radar apparatus is housed within a housing 11. The radar apparatus is also provided with a temperature sensor 10, such as a thermocouple. This is used to determine the temperature of part of the radar apparatus, for example the housing 11 or alternatively the signal generation unit 1. In order to still allow the radar apparatus to function at all above its otherwise usual high temperature limit, the control unit 9 controls the signal generation unit 1 to reduce the power of the signals generated by the signal generation unit 1 at high temperatures, as shown in FIG. 2 of the accompanying drawings, in order to avoid malfunctioning of the radar apparatus due to overheating.

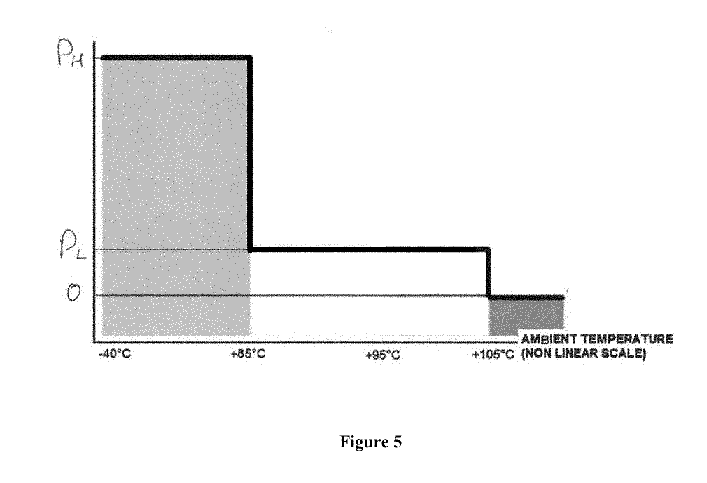

FIG. 2 shows schematically the power at which the signal generation unit 1 will operate with the temperature as detected by the temperature sensor 10. In a first range, in FIG. 2 from −40° C. to +85° C., the signal generation unit operates at a first power P_{H}. In a second range, in FIG. 2 from 95° C. to 105° C., the signal generation unit 1 operates at a second power P_{L}, which is 3 dB lower than P_{H}—that is half the power of P_{H}. In a third range between the first and second ranges (so between 85° C. and 95° C.), there is a linear transition from P_{H} to P_{L}. Thus, the power applied gradually reduces over the third range. Alternatively, there could be no third range, and there could be an abrupt drop in power between the adjacent first and second ranges, as shown in FIG. 5 of the accompanying drawings.

Above the second range—so above 105° C., the signal generation unit 1 ceases operating. This value of 105° C. is higher than would have previously been achieved with the same circuit operating at full power.

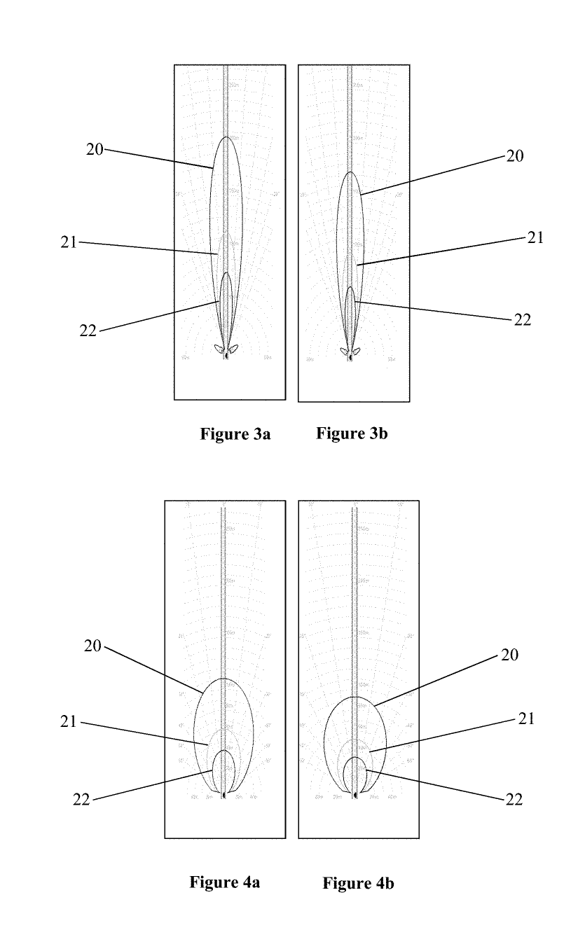

The inventors have appreciated that even at reduced transmission power, useful results can be had from the radar apparatus. This can be seen in FIGS. 3a and 3b, and FIGS. 4a and 4b of the accompanying drawings. In FIGS. 3a and 3b, the beam pattern used with a particular transmission antenna 3 used in a higher range mode is shown at full power (P_{H}) in FIG. 3a and at low power (P_{L}) in FIG. 3b. We have highlighted particular distances to show where it would still be possible to detect certain elements. Line 20 shows where it would be possible to detect a car, line 21 a cyclist and line 22 a pedestrian. As such, whilst there is some reduction in range, it is still possible to detect these elements at short range, which is arguably the most important part of the detection field to maintain. There is also an increase in the angular field of view.

In FIGS. 4a and 4b, equivalent diagrams to FIGS. 3a and 3b for a second embodiment of the radar apparatus are shown, with the transmission antenna 3 in a lower range mode. The same lines are depicted for full power (FIG. 4a) and low power (FIG. 4b) respectively. The same conclusions can be drawn.

The following table shows the maximum ranges for the different detected elements at full and low power:

| Mode | |
|---|---|
| Higher range - | Lower range - |
| FIGS. 3a/3b | FIGS. 4a/4b |

| Power | P_{H} | P_{L} | P_{H} | P_{L} |
|---|---|---|---|---|
| Car | 200 m | 170 m | 110 m | 80 m |
| Cyclist | 115 m | 95 m | 60 m | 50 m |
| Pedestrian | 75 m | 65 m | 40 m | 35 m |

This still gives useable results, even when reducing the power to avoid the effects of overheating.

The principle and mode of operation of this invention have been explained and illustrated in its preferred embodiment. However, it must be understood that this invention may be practiced otherwise than as specifically explained and illustrated without departing from its spirit or scope.

1. A radar apparatus, comprising:
a signal generation unit arranged to generate radar signals at an output power, the signal generation unit having an output for the radar signals,
a temperature sensor having an output and arranged to produce at its output an output signal indicative of a temperature of at least part of the radar apparatus, the output of the temperature sensor being coupled to the signal generation unit,
in which the signal generation unit is configured so the output power is a first power when the output signal is indicative of a temperature within a first temperature range and is a second power that is lower than the first power when the output signal is indicative of a temperature within a second temperature range that is higher than the first temperature range.

2. The radar apparatus of claim 1, in which the first and second temperature ranges are adjacent.

3. The radar apparatus of claim 1, in which there is a third temperature range between the first and second temperature ranges, with the signal generation unit being arranged to as to decrease the output power as the output signal indicates a temperature increasing through the third range.

4. The radar apparatus of claim 1, in which the signal generation unit is arranged so as to cease generating radar signals when the output signal indicates a temperature above a threshold, the threshold being higher than the second range.

5. The radar apparatus of claim 1, comprising a transmitter for the radar signals, coupled to the output of the signal generation unit, the transmitter comprising at least one antenna.

6. The radar apparatus of claim 1, comprising a receiver for received radar signals, which comprises at least one receiving antenna and optionally a reception unit which is arranged to detect and process the received radar signals.

7. A method of operating a radar apparatus, comprising:
generating radar signals at an output power using the radar apparatus;
measuring the temperature of at least part of the radar apparatus; and
varying the output power to a first power when the temperature is within a first temperature range and to a second power lower than the first power when temperature is within a second temperature range higher than the first temperature range.

8. The method of claim 7, in which the first and second temperature ranges are adjacent.

9. The method of claim 7, in which there is a third temperature range between the first and second temperature ranges.

10. The method of claim 9, comprising decreasing the output power as the temperature increases through the third range, typically from the first power to the second power.

11. The method of claim 7, in which the second power is 3 decibels less than the first power, to within one of 0.5, 0.25 or 0.1 decibels.

12. The method of claim 7, in which the highest temperature in the first range may be between 80 and 90 degrees Celsius.

13. The method of claim 12, in which the highest temperature in the first range may be between 84 and 86 degrees Celsius.

14. The method of claim 7, comprising ceasing to generate radar signals should the output signal indicate a temperature above a threshold, the threshold being higher than the second range.

15. The method of claim 7, comprising using a radar apparatus, the radar apparatus comprising:
a signal generation unit arranged to generate radar signals at an output power, the signal generating unit having an output for the radar signals,
temperature sensing means having an output and arranged to produce at its output an output signal indicative of a temperature of at least part of the radar apparatus, the output of the temperature sensor being coupled to the signal generation unit,
in which the signal generation unit is configured so the output power is a first power when the output signal is indicative of a temperature within a first temperature range and is a second power lower than the first power when the output signal is indicative of a temperature within a second temperature range higher than the first temperature range.
